(19) United States
(12) Patent Application Publication
(10) Pub. No.: US 2006/0172910 A1
(43) Pub. Date: Aug. 3, 2006

(54) Machine cleaner

(75) Inventors: Anju Deepali Massey Brooker, Newcastle/Tyne (GB); Harold Emmerson, Murcia (ES); Jun Wang, Newcastle/Tyne (GB); Jose David Baez Chavez, Newcastle upon Tyne (GB)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/329,008

(22) Filed: Jan. 10, 2006

(30) Foreign Application Priority Data
Jan. 10, 2005 (EP) 05250082.4

(51) Int. Cl. C11D 17/00

(52) U.S. Cl. 510/293; 510/395; 510/439

(57) ABSTRACT

Machine cleaner product in the form of a water-soluble single- or multi-compartment pouch comprising a limescale removing composition and a water-soluble enveloping material.

### TECHNICAL FIELD

The present invention is in the field of cleaning appliances, more specifically the invention relates to a machine cleaner product in the form of a water-soluble single- or multi-compartment pouch comprising a limescale removing composition and a water-soluble enveloping material, a process for making the product and a method for using it for cleaning the interior of a dishwasher or laundry machine.

### BACKGROUND

The surface of the interior of a dishwasher or laundry machine becomes covered with residues over the course of time. The kind of residues found most frequently are: limescale, soap scum and soil deposits (for example, food residues in the case of dishwashers). Limescale is formed from the insolubilisation of ions contained in tap water. The limescale deposits in the interior of the machine are mainly found on the heater elements. Such deposits are undesirable not only from the aesthetic aspect but also because they can interfere with the heat exchange process resulting in a less efficient use of energy. The soap scums are remnants from the detergents. The soil deposits are mainly deposited on the filter.

The use of acidic cleaning compositions to remove limescale is well-known in the art (see for example U.S. Pat. No. 5,733,859, EP-A-0,496,188 and EP-A-0,601,990). U.S. Pat. No. 5,877,132 discloses an aqueous cleaning composition for removing limescale from surfaces wherein the composition comprises a biodegradable aqueous acidic system, preferably a surfactant and additional components selected from thickeners, co-builders and enzyme mixtures. The enzyme mixtures comprise carbohydrase and gluconase enzymes. Liquid and granular acidic compositions are traditionally used to clean the interior of automatic dishwashers. EP-A-0,256,148 discloses a cleaner composition for dishwashing machine interiors comprising citric acid and low-foaming non-ionic surfactant. U.S. Pat. No. 5,981,449 discloses an aqueous cleaning composition for removing limescale in automatic dishwashers and laundry machines. The cleaning composition comprises maleic acid and an acid-stable thickener. U.S. Pat. No. 4,465,612 describes a process for cleaning and maintaining dishwashing interiors. The cleaning composition is a liquid containing an acid, an alcohol a low-sudsing non-ionic surfactant and customary additives.

The use of organic acids for limescale removal in appliances is preferred over the use of inorganic acids, because the former are safer to the metal and plastic materials of the appliance interior surface. In particular some corrosion/staining may occur when metal surfaces such as aluminium, chromed steel or stainless steel are treated with inorganic acids.

A problem found with the most commonly used limescale remover acids is that they are crystalline materials. These crystalline materials often show poor flow properties and storage stability issues, probably because of the interaction with moisture of the surrounding environment. They tend to be rather sticky, having an unappealing appearance to consumers.

Another problem encountered with crystalline materials is that they are difficult to process, especially if the final composition require the presence of liquid ingredients such as non-ionic surfactants. The crystalline materials are usually free of pores and therefore not suitable for absorbing liquid ingredients. These materials are difficult to granulate, when a liquid material is added to the crystalline materials the mixture becomes sluggish, the binding forces do not seem strong enough to form granules.

EP 612,843 proposes a process for granulating an organic crystalline material by combining the crystalline material with a water-insoluble powdered material and water or an aqueous solution of a film-forming polymeric material. '843 seems to solve the problem of the flowability of the crystalline material; however, it does not address the processability of the crystalline material in the presence of liquid ingredients or storage stability in the presence of moisture or elevated humidity conditions.

WO 01/62886 proposes a machine cleaner tablet comprising a limescale remover acid, a non-ionic surfactant and enzymes. In order to process the active ingredients a carrier for the non-ionic surfactant is required. For tablet formation purposes a binder is also used.

The acid compositions can alternatively be in liquid form. In the case of liquid compositions the volume is considerably greater than a solid composition with the same amount of acid. This can be a problem, especially if the volume of the cleaning composition that can be used is limited by the physical dimensions of the machine dispenser.

Usually a dishwashing program comprises a pre-wash, main-wash and one or more rinse cycles. The longest cycle and where the operation conditions provide the best cleaning is the main-wash. Therefore, when designing a method for cleaning the machine, the cleaning composition should be active at least in the main-wash. In each cycle of the dishwashing process the machine is filled with water and the water is subsequently flushed out at the end of each cycle, thus if a cleaning composition is delivered into the pre-wash, it will be flushed out before the main-wash thereby precluding the action of the composition during the most active cycle.

Another problem found with acidic compositions is incompatibility with certain ingredients, such as enzymes and perfumes.

The objective of the present invention is to provide a storage-stable machine cleaner composition which addresses some or all of the above mentioned drawbacks.

### SUMMARY OF THE INVENTION

According to the first aspect of the present invention there is provided a machine cleaner product in the form of a water-soluble single- or multi-compartment pouch comprising a limescale removing composition and a water-soluble enveloping material. Some of the ingredients of the limescale removing composition may be skin irritants. The enveloping material precludes the contact between the user's skin and the composition.

By machine cleaner product is understood a product suitable for the cleaning of appliance interior, in particular dishwashers and laundry washing machines. The interior surfaces of the machines can become soiled with limescale, soap scums and greasy residues among other things. A machine cleaner product is designed to remove these kinds of soils, which are not usually removed with the normal cleaning products, such as dishwashing or laundry detergents.

Except where otherwise indicated the term “pouch” herein includes both flexible and non-flexible walled products in unit dose form in which a cleaning composition is enveloped, i.e., surrounded by, a water-soluble material, preferably in the form of a film. For example terms such as sachet, container made by injection moulding or capsule are encompassed by the term “pouch”.

Preferably, the machine cleaner product of the invention has a pH when dissolved in 5 l of distilled water at 20° C. of from about 1 to about 4, more preferably from about 1.5 to about 2.8 and even more preferably from about 2 to about 2.6. The pH is measured 30 seconds after the pouch has been introduced into a bath containing 5 l of distilled water, under low agitation conditions (about 500 rpm), for example using a IKA LABORTECHNIK stirred, model RET Basic.

The limescale removing composition can comprise only one acid, preferably citric or maleic acid or a sulphate salt or mixtures thereof. In a preferred embodiment the limescale removing composition comprises one or more limescale remover acids. Preferably the composition comprises a first acid having a pKa₁ of at least about 3, preferably citric acid, and a second acid having a pKa₁ of no more than about 2, preferably maleic acid. The first and second acids are preferably in a weight ratio of from about 1:10 to about 10:1, more preferably from about 1:1 to about 5:1. This combination of acids favours the removal of limescale without damaging the interior surfaces of appliances. A preferred combination of acids is a mixture of citric and maleic acid in a weight ratio of from about 2:1 to about 5:1, more preferably from about 3:1 to about 4:1.

In another preferred embodiment the limescale removing composition comprises maleic acid and more preferably maleic acid in combination with one or more sulphate salts in a weight ratio of from about 1:1 to about 5:1, preferably from about 2:1 to about 3:1. In such embodiments, the limescale removing composition is preferably essentially free (less than about 1% thereof) of citric acid, this being preferred from the viewpoint of minimizing the moisture pick up of the composition.

The limescale removing composition can comprise only one acid, preferably citric or maleic acid or a sulphate salt or mixtures thereof. Citric acid is the most preferred acid for use herein.

Preferably, the limescale removing composition comprises an anticaking agent, such as silica gel, for reasons of water-soluble enveloping material stability and processability.

Preferred compositions comprise citric acid and an anticaking agent. Preferably, the composition comprises an antioxidant.

The machine cleaner of the invention can be a single-compartment pouch. Preferably, it is a multi-compartment pouch providing great flexibility for chemistry separation. Different chemistries can be located into different compartments, permitting the separation of incompatibles ingredients or ingredients in different physical forms, for example separation of liquids and solid ingredients.

In a preferred embodiment the machine cleaner product is in the form of a multi-compartment pouch containing the first and second acids in solid form and preferably in the same compartment of the pouch. Preferably, the pouch also has a liquid compartment comprising a liquid surfactant composition capable of providing grease cleaning and finishing benefits, including improved shine and drying of the machine surfaces.

In another preferred embodiment the liquid compartment contains a perfume. Most perfumes are unstable in acidic media. The product of the invention can simultaneously deliver a good cleaning and a pleasant smell by separating the limescale remover acid(s) from the perfume.

For reasons of film stability, the liquid composition preferably comprises a C2-C6 monoalkylene polyol or a mixture thereof, preferably C2-C3 monoalkylene polyol having a preferred molecular weight of less than about 100. Preferred C2-C3 monoalkylene polyols for use herein include glycerol, ethylene glycol, propylene glycol and mixtures thereof, especially preferred being glycerol. Preferably, the C2-C6 monoalkylene polyol is present in the liquid composition in a level of from about 0.05 to about 5%, more preferably from about 0.5 to about 2% by weight of the liquid composition.

Also for reasons of film stability, the liquid composition preferably comprises from about 1 to about 10%, preferably from about 1.5 to about 5% by weight of the liquid composition of water.

In terms of levels, the product of the invention preferably comprises from about 20% to about 99.5%, more preferably from about 30% to about 95% by weight of the product of a limescale remover acid or mixtures thereof and from about 0.1% to about 20%, preferably from about 0.5% to about 15% by weight of the product of non-ionic surfactant. Additionally the product can comprise the customary ingredients found in a machine cleaner.

In terms of pouch configuration, in a preferred embodiment the pouch is a multi-compartment pouch, preferably a dual-compartment pouch, comprising a first compartment containing a composition in solid form and a second compartment containing a composition in liquid form. Preferably the solid:liquid compositions are in a weight ratio of from about 1:50 to about 50:1, preferably from about 2:1 to about 30:1. Preferably the total weight of the pouch is from about 10 to about 30 grams, more preferably from about 15 to about 22 grams. Preferably the solid compartment contains a limescale remover acid and more preferably a perfume in combination with an antioxidant. The antioxidant improves the stability of the perfume. The solid compartment might additionally contain a dye and preferably a small amount of non-ionic surfactant (from about 0.001 to about 2% by weight of the solid composition). The liquid compartment optionally comprises a liquid surfactant and preferably a perfume.

In a preferred configuration, the pouch has two, or more compartments arranged in a superposed manner, preferably the solid and liquid compartments have similar footprints. This execution is particularly suitable for the case of liquid compartments superposed over solid compartments. The liquid compartment can protect the solid compartment from moisture pick up from the surrounding environment. Some of the limescale remover acids are prone to adsorb water which can affect powder flowability and the stability of the water-soluble enveloping material. The water pick up can be minimised by placing the liquid compartment on top of the solid compartment. Moisture pick up can also be reduced by having a moisture transfer barrier either on the limescale remover acid and/or other ingredients prone to pick up water and/or the enveloping material. Preferably, the moisture transfer barrier comprises a material which renders surfaces hydrophobic or reduces the permeability of the enveloping material. The material provides protection during storage but releases the protected ingredients during the cleaning process. Preferred materials which can act as moisture transfer barriers are waxes, especially waxes having a melting point above about 40° C., preferably about 50° C. and below about 80° C., preferably about 70° C. The flowability of the solid compartment can be improved by adding an anticaking agent to the composition, in particular when the composition is in powder form.

In preferred machine cleaner products of the invention, the limescale removing composition has a moisture pick up of less than about 10%, more preferably less than about 5% and most preferably less than 1%, moisture pick up being measured by storing in a room 2 g of dried limescale removing composition (initial weight: W1) in an atmosphere maintained for a period of 24 hours at 32° C. and 80% relative humidity. The difference between the final weight W2 (weight of the limescale removing composition after the 24 hours) and the dried weight W1 divided by W1 and multiplied by 100 gives the moisture pick up. The test is repeated with six samples or with a number of samples enough to assure reproducibility.

For the purposes of moisture pick up measurements, a limescale removing composition is taken to the dried state using a Mettler LP16 infrared drier and a Mettler PM600 balance. The 2 g sample is dried at 120° C. until a constant weight is reached.

Certain of the preferred limescale remover acids, for example citric acid, are crystalline materials which can have sharp edges. The edges can tear the enveloping material and break the pouch open. In order to avoid this, the limescale remover acid edges are preferably rounded by for example, grinding, spheronisation, etc. In preferred embodiments the limescale remover acid is in edge-rounded particulate form.

According to another aspect of the invention, there is provided a process for making a single- or multi-compartment pouch, especially the machine cleaner pouch of the invention, comprising the steps of:
a) making open pocket(s) of a water-soluble film;
b) filling and closing the pocket(s); and optionally
c) coating the formed pouch with a moisture transfer barrier.

Step c) can be omitted for example if the limescale remover acid or other ingredients prone to moisture pick-up are themselves protected with a moisture transfer barrier, for example, in the case of particulate limescale remover acids which have been protected by coating using for example a spray-on melted wax.

In a preferred embodiment the limescale remover acid placed into the open pocket(s) is in the form of edge-rounded particles.

According to a method aspect of the invention, there is provided a method of cleaning the interior of a dishwasher or laundry washing machine comprising the steps of:
a) placing a water-soluble single- or multi-compartment machine cleaner pouch, preferably the machine cleaner product of invention, in the interior of the dishwasher or laundry machine; and
b) running the dishwasher or laundry machine in the absence of a dishwashing or laundry load.

In a preferred embodiment the pouch is placed into the machine dispenser, this is important, especially in the case of a dishwasher because it will protect the product during the pre-wash and will only release it into the main-wash, maximising the effect of the cleaning product.

### DETAILED DESCRIPTION OF THE INVENTION

The present invention encompasses a product designed for cleaning machine interiors, the product being in the form of a water-soluble single- or multi-compartment pouch comprising a limescale removing composition and a water-soluble enveloping material, a process for making the product and a method of cleaning a machine using the product of the invention.

In preferred embodiments, the machine cleaner product is in the form of a multi-compartment pouch having a compartment containing a solid composition and a compartment containing a liquid composition. Preferably the solid composition comprises citric acid as limescale remover acid, more preferably in combination with an anticaking agent, in particular silica gel and even more preferably, the solid composition further comprises non-ionic surfactant. For aesthetic reasons the solid composition preferably comprises a dye and a perfume. The liquid composition preferably comprises non-ionic surfactant.

By “water-soluble material” is meant a material soluble or dispersible in water having a water-solubility of at least 50%, preferably at least 75% or even at least 95%, as measured by the method set out here after using a glass-filter with a maximum pore size of 20 microns.

50 grams±0.1 gram of pouch material is added in a pre-weighed 400 ml beaker and 245 ml±1 ml of distilled water is added. This is stirred vigorously on a magnetic stirrer set at 600 rpm, for 30 minutes. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the % solubility or dispersability can be calculated.

Preferred pouch materials are polymeric materials, preferably polymers which are formed into a film or sheet. The pouch material can, for example, be obtained by casting, blow-moulding, injection moulding, extrusion or blown extrusion of the polymeric material, as known in the art.

The machine cleaner product of the invention preferably has a shape and size suitable for fitting within the majority of machine dispensers. This simplifies the manufacturing process by producing a pouch that can be used in any machine.

Limescale remover acids preferred for use herein are selected from water-soluble organic mono- and polycarboxylic acids with two to six carbon atoms in the molecule and optionally substituted by one or more hydroxy groups. Suitable classes of limescale remover include alkanoic acids, hydroxyalkanioc acids, alkyl polycarboxylic acids and hydroxyalkyl polycarboxylic acids. Preferred herein are mono- and polycarboxylic acids which have a pKa value, related to the first dissociation stage (pKa₁) of no more than about 6. These include for example, adipic acid, succinic acid, tartaric acid, malic acid, maleic acid, glutaric acid, citric acid and mixtures thereof. Mixtures of citric acid and maleic acid in the weight ratio specified hereinabove are highly preferred.

Although less preferred, inorganic acids and mixtures of inorganic acids and organic acids can also be used as the limescale remover component. The inorganic acids are specially useful when mixed with organic acids. Examples of inorganic acids are sulphonic acid derivatives, sulphamic acid (pKa=0.1), hydrochloric acid (pKa<0), nitric acid (pKa<0), phosphoric acid (pKa=2.1) and sulphuric acid (pKa=0.4). Suitable sulphonic acid derivatives include alkyl sulphonic acids and aryl sulphonic acids. Suitable alkyl sulphonic acids include C1-C6 linear or branched alkylsulphonic acids or mixtures thereof, such as methanesulphonic acid (pKa=1.9) commercially available for example from Aldrich, William Blythe & Co. Ltd. or Elf. Atochem.

Also preferred for use herein are mixtures of maleic acid and salts of sulphuric acid, such as sodium sulphate. Preferably in the weight ratio specified hereinabove.

Suitable aryl sulphonic acids for use herein include those of the formula: 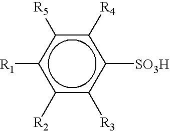
wherein R1, R2, R3, R4 and R5 are each H or SO₃H, or linear or branched C1-C4 alkyl chain; or mixtures thereof, the total number of C1-C4 alkyl chains preferably being no more than 2.

Preferred arylsulphonic acids to be used are those which comprise no or only one alkyl chain. Arylsulphonic acids are particularly effective at removing limescale, which is not the case for their alkyl chain homologues. Also arylsulphonic acids are particularly safe to the surface treated therewith. Particularly suitable arylsulphonic acids for use herein are benzene sulphonic acid (pKa=0.7), toluene sulphonic acid and cumene sulphonic acid. Amongst these three, at equal weight %, the lower and shorter the alkyl chain substitution, down to no substitution at all, the better the limescale removing performance.

Preferably, the limescale remover acid (or acids) is used in its lower hydration form, more preferably in anhydrous form, for enveloping material stability reasons.

Specially preferred for use herein is citric acid in granulated form, in particular citric acid having a particle size between about 4 mm and about 0.01 mm, more preferably between about 2 mm and about 0.1 mm and specially preferred is citric acid having a particle size between about 0.7 and about 0.3 wherein only less than 10% of the material has a particle size below or above this range.

Preferably, the limescale removing composition comprises an anticaking agent. Suitable anticaking agents for use herein include p-toluenesulfonic acid salts, xylenesulfonic acid salts, acetic acid salts, sulfosuccinic acid salts, talc, finely powdered silica, clay and magnesium oxide. Preferred silica for use herein is that having a mean particle size (following ASTM c 690-1992) of from about 1 to about 100 μm, more preferably from about 2 to about 50 μm. A preferred silica for use herein, in particular in combination with citric acid is that sold by Degussa under the tradename of Sipernat®, in particular Sipernat® 22 S. In a preferred embodiment the machine cleaner product of the invention is in the form of a multi-compartment pouch comprising a compartment containing a liquid composition and a compartment containing a solid composition, preferably in powder composition. Preferably the composition comprises citric acid and an anticaking agent, in particular silica. Preferably, the limescale removing composition comprises from about 1 to about 10, more preferably from about 2 to about 6% by weight of the composition of anticaking agent.

Preferably, the limescale removing composition comprises a perfume and an antioxidant. Examples of antioxidants include t-butylhydroxytoluene, 4,4′-butylidenebis(6-t-butyl-3-methylphenol), 2,2′-butylidenebis(6-t-butyl-4-methylphenol), monostyrenated cresol, distyrenated cresol, monostyrenated phenol, distyrenated phenol and 1,1′-bis(4-hydroxyphenyl)cyclohexane. Preferably, the composition comprises from about 0.01 to about 4, more preferably from about 0.1 to about 2% by weight of the composition of antioxidant.

Suitable nonionic surfactants according to the present invention includes nonionic alkoxylated surfactants (especially ethoxylates derived from C₆-C₁₈ primary alcohols), ethoxylated-propoxylated alcohols (e.g., Olin Corporation's Poly-Tergent® SLF18), epoxy-capped poly(oxyalkylated) alcohols (e.g., Olin Corporation's Poly-Tergent® SLF18B—see WO-A-94/22800), ether-capped poly(oxyalkylated) alcohol surfactants, and block polyoxyethylene-polyoxypropylene polymeric compounds such as PLURONIC®, REVERSED PLURONIC®, and TETRONIC® by the BASF-Wyandotte Corp., Wyandotte, Mich. Surfactants suitable herein are disclosed, for example, in U.S. Pat. No. 3,929,678, U.S. Pat. No. 4,259,217, EP-A-0414 549, WO-A-93/08876 and WO-A-93/08874. Highly preferred non-ionic surfactants include alkyl ethoxylated/propoxylated surfactants having a degree of ethoxylation higher than the degree of propoxylation and having an average of from about 4 to about 9 moles of EO per mol of alcohol, from about 1 to about 4 moles of PO per mol of alcohol and preferably at least about 25%, more preferably at least about 75% of surfactant having an alkyl chain being linear and containing from about 6 to about 15 carbon atoms. These surfactants preferably have a surface tension of from about 35 to about 27 mN/m as measured in a 1% by weight aqueous solution at 20° C. Preferably, these surfactants are low foaming. Preferred non-ionic ethoxylated/propoxylated fatty alcohol surfactants are Plurafac surfactants, available from BASF, especially those of the RA series, in particular Plurafac RA30.

Also preferred for use herein are the alkyl ethoxylate condensation products of aliphatic alcohols with an average of from about 4 to about 10, preferably form about 5 to about 8 moles of ethylene oxide per mol of alcohol are suitable for use herein. The alkyl chain of the aliphatic alcohol generally contains from about 6 to about 15, preferably from about 8 to about 14 carbon atoms. Particularly preferred are the condensation products of alcohols having an alkyl group containing from about 8 to about 13 carbon atoms with an average of from about 6 to about 8 moles of ethylene oxide per mole of alcohol. Preferably at least 25%, more preferably at least 75% of the surfactant is a straight-chain ethoxylated primary alcohol. It is also preferred that the HLB (hydrophilic-lipophilic balance) of the surfactant be from about 7 to about 13. Commercially available products for use herein include Lutensol®TO series, C13 oxo alcohol ethoxylated, supplied by BASF, especially suitable for use herein being Lutensol®TO7.

The nonionic surfactants are typically present at a level of from about 1% to about 20% by weight, more preferably from about 2% to about 18% by weight, most preferably from about 4% to about 15% by weight of product.

Other suitable surfactants for use herein include super-wetting surfactants, in particular a range of siloxane and hydrocarbon based surfactants. Preferably, the super-wetting surfactant is selected from the group consisting of: i) polyoxyalkylene siloxanes wherein the polyalkylene oxide residue has the general formula (EO)ₙ(PO)ₘ wherein EO is ethoxy, PO is propoxy, n is at least about 3 and greater than m; ii) non-ionic ethoxylated alcohols having an average of from about 4 to about 10 moles of EO per mol of alcohol and an average chain length of from about 6 to about 15 carbon atoms; iii) and mixtures thereof. The non-ionic alkyl ethoxylated super-wetting surfactants are preferably free of propoxy groups.

The trisiloxane surfactant preferred for use herein is a polyalkylene oxide-modified dimethyltrisiloxane, preferably a linear methyltrisiloxane to which polyethers have been grafted through a hydrosilation reaction. This process results in an alkyl-pendant (AP type) copolymer, in which the polyalkylene oxide groups are attached along the siloxane backbone through a series of hydrolytically stable Si—C bonds. The siloxane surfactants herein described are sold under the brand SILWET® available from Union Carbide or ABIL® polyethersiloxanes available from Goldschmidt Chemical Corp. Preferred siloxane for use herein are Silwet L77, Silwet L7280, Silwet L7607 and Silwet L7608. Silwet L7280 is especially preferred for its environmental profile. Other suitable siloxane surfactants are those supplied by Degusa (sold under the numbers 5840, 5847 and 5878), DowCorning (sold under the numbers DC 5211 and DC5212) and Waker (sold under the number L066).

Preferably, in multi-compartments executions comprising a compartment containing a liquid composition and a compartment containing a solid composition, non-ionic surfactant is placed in both compartments. The non-ionic surfactant in the solid composition, in particular if the composition is in powder form, favours the process and flowabiliy of the composition.

Preferably the product of the invention further comprises one or more additional ingredients selected from the group consisting of: organic carriers, antifoaming agents, humectants, dispersants, crystal growth inhibitors, enzymes, perfumes, dyes and mixtures thereof. Compositions comprising dispersants or crystal growth inhibitors are especially preferred, because they reduce/avoid the formation of water marks on the machine interior.

Organic Carriers

Organic carriers are preferably low molecular weight primary or secondary alcohols selected from the group consisting of: methanol, ethanol, propanol, isopropanol, glycerol, propylene glycol, ethylene glycol, 1,2-propanediol, sorbitol and mixtures thereof. If used the organic carriers are used in a level of from about 0.5% to about 40%, preferably from about 0.8% to about 35% and more preferably form about 0.9% to about 25% by weight of the liquid component of the product.

Dispersant and Crystal Growth Inhibitors

The function of the dispersant is to suspend the inorganic salts in the wash liquor and minimise their deposition onto dishware. Some dispersants can also act as crystal growth inhibitors.

Suitable for use as dispersants herein are co-polymers synthesised from acrylic acid, maleic acid and methacrylic acid such as Acusol 480N supplied by Rohm & Haas and polymers containing both carboxylate and sulphonate monomers, such as Alcosperse polymers (supplied by Alco).

Preferred crystal growth inhibitors for use herein include organodiphosphonic acids. By organo diphosphonic acid it is meant herein an organo diphosphonic acid which does not contain nitrogen as part of its chemical structure. This definition therefore excludes the organo aminophosphonates, which however may be included in compositions of the invention as heavy metal ion sequestrant components.

The organo diphosphonic acid is preferably a C₁-C₄ diphosphonic acid, more preferably a C₂ diphosphonic acid, such as ethylene diphosphonic acid, or most preferably ethane 1-hydroxy-1,1-diphosphonic acid (HEDP) and may be present in partially or fully ionized form, particularly as a salt or complex.

Silicone Antifoaming Agents

Suitable antifoaming agents can be selected from the group consisting of silicon based antifoams, particularly conventional inorganic-filled polydimethylsiloxane antifoam agents, especially silica-filled polydimethylsiloxane antifoam agents as disclosed in U.S. Pat. No. 4,639,489 and U.S. Pat. No. 3,455,839. These and other suitable antifoam agents are commercially available under the tradenames of Silcolapse 431 and Silicone EP 6508 from ICI United States Inc., Wilmington, Del., U.S.A., Rhodosil 454 from Rhone-Poulenc Chemical Co., Monmouth Junction, N.J., U.S.A.; and Silkonol AK 100 commercially available from Wacker-Chemie G.m.b.H., Munich, Federal Republic of Germany.

Humectants

Humectant is a substance which can pick up or emit moisture to the surroundings depending on the surrounding relative humidity. Humectants suitable for use herein include non-aqueous hydrophilic organic solvents inclusive of glycols and polyhydric alcohols, for example sorbitol, glycerol, dipropylene glycol and mixtures thereof.

Process

In a preferred embodiment of the present invention the machine cleaner product is a multi-phase unit dose product, preferably a vacuum- or thermoformed multi-compartment water-soluble pouch, wherein one of the phases preferably comprises a limescale removing composition. Preferred manufacturing methods for unit dose executions are described in WO 02/42408. Any water-soluble film-forming polymer which is compatible with the compositions of the invention and which allows the delivery of the composition into the main-wash cycle of a dishwasher or laundry washing machine can be used as enveloping material.

The single compartment pouches of the invention can be made by placing a first piece of film in a mould, drawing the film by vacuum means to form a pocket, filling the formed pocket with a limescale removing composition, preferably including the moisture regulator system, and placing and sealing the formed pocket with another piece of film.

The multi-compartment pouches of the invention can be made by placing a first piece of film in a mould, drawing the film by vacuum means to form a pocket, pinpricking the film, dosing and tamping the powder composition, placing a second piece of film over the first pocket to form a new pocket, filling the new pocket with the liquid composition, placing a piece of film over this liquid filled pocket and sealing the three films together to form the dual compartment pouch.

In preferred process embodiments the limescale removing composition is prepared by forming a liquid premix, preferably comprising non-ionic surfactant and spraying this premix onto a powder mixture comprising the limescale remover acid, thereby improving the processability of the composition.

### EXAMPLES

| | Composition (grams) | | |
|---|---|---|---|
| | A | B | C |
| Solid | | | |
| Lutensol TO7¹ | | | 0.1 |
| LF224² | | | 0.05 |
| Citric acid (anhydrous)³ | 12.5 | | 13.7 |
| Maleic acid | 4 | 12.5 | |
| Sodium sulphate | | 4.7 | |
| Silica gel⁴ | | | 0.6 |
| BHT⁵ | | | 0.06 |
| Dye | | | 0.001 |
| Perfume | 0.5 | 0.5 | 0.2 |
| Liquid | | | |
| Lutensol TO7¹ | 2 | 2 | 1.3 |
| LF224² | 1 | 1 | 0.7 |
| Glycerol | 0.03 | 0.03 | 0.02 |
| Water | 0.05 | 0.05 | 0.04 |
| Dye | | | 0.0003 |

¹C13 oxo alcohol ethoxylated, available from BASF
²Fatty alcohol alkoxylated non-ionic surfactant available from BASF
³Grade F6049 available from Jungbunzlauer
⁴Sipernat ® 22 S available from Degussa
⁵butylated hydroxytoluene

### Example 1

Composition A (or B) is introduced into a two superposed compartment PVA rectangular base pouch. The dual compartment pouch is made from a Monosol M8630 film as supplied by Chris-Craft Industrial Products. 17 g of the solid composition (in the case of composition A or 17.7 g in the case of composition B) and 3.08 g of the liquid composition are placed in the two different compartments of the pouch. The pouch is manufactured by making an open pocket with a PVA film, filling it with the solid composition, placing a PVA film over the open pocket and sealing the two films to create a new open pocket, the new pocket is filled with the liquid composition, a piece of PVA is placed over it and the new pocket is sealed giving rise to a dual compartment pouch.

### Example 2

The liquid part of composition C is prepared by dissolving dye in water and forming a premix with the surfactants and glycerol. The dissolved dye and the premix are mixed in a high shear mixer to produce the final liquid composition.

The solid part of composition C is prepared by forming two liquid premixes and a liquid premix. The first liquid premix comprises the surfactants and the dye and the second premix the perfume and BHT. The solid premix comprises the citric acid and the silica gel. The two liquid premixes are sprayed onto the powder premix to produce the final powder composition.

Composition C is introduced into a two superposed compartment PVA rectangular base pouch. The dual compartment pouch is made from a Monosol M8630 film as supplied by Chris-Craft Industrial Products. The solid composition (about 16 g) and the liquid composition (about 2.1 g) are placed in the two different compartments of the pouch. The pouch is manufactured by making an open pocket with a PVA film, filling it with the solid composition, placing a PVA film over the open pocket and sealing the two films to create a new open pocket, the new pocket is filled with the liquid composition, a piece of PVA is placed over it and the new pocket is sealed giving rise to a dual compartment pouch.

### Example 3

The process of example 1 is repeated but the acid is ground using a REVEL coffee blender, for about 30 seconds, in order to round the edges of the particles.

### Example 4

The process of example 1 is repeated and the resulting pouch is coated with melted paraffin wax, having a congealing point of about 51-53° C.

### Example 5

The process of example 1 is repeated but the solid composition is coated by spraying-on melted paraffin wax over the solid composition, prior to the introduction into the preformed pocket.

The pouch of example 1 is introduced into the 25 ml dispenser compartment of a Bosch Siemens 6032 dishwashing machine, the dispenser is closed and the machine is operated in the absence of a dishwashing load in its normal 55° C. program. After the program has finished, the machine interior is found clean, shining, free of limescale and having a very pleasant smell.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications can be made without departing from the spirit and scope of the invention. It is therefore intended to cover in the appended claims all such changes and modifications that are within the scope of this invention.

What is claimed is:

1. A machine cleaner product in the form of a water-soluble single- or multi-compartment pouch comprising a limescale removing composition and a water-soluble enveloping material and wherein said limescale removing composition comprises one or more limescale remover acids.

2. A machine cleaner product according to claim 1 having a pH when dissolved in 5 l of distilled water at 20° C. of from about 1.0 to about 4.

3. A machine cleaner product according to claim 1 wherein the limescale removing composition comprises citric acid as limescale remover acid.

4. A machine cleaner product according to claim 1 comprising a first acid having a pKa₁ of at least about 3 and a second acid having a pKa₁ of no more than about 2 and wherein the first and second acids are in a weight ratio of from about 1:10 to about 10:1 and wherein the first and second acids are in solid form and included in the same compartment of the pouch.

5. A machine cleaner product according to claim 1 in the form of a multi-compartment pouch wherein at least one of the compartments of the pouch comprises a liquid composition comprising a non-ionic surfactant.

6. A machine cleaner product according to claim 1 comprising:
a) from about 20% to about 99.5% by weight of the product of a limescale remover acid or mixture thereof;
b) from about 0.1% to about 20% by weight of the product of non-ionic surfactant.

7. A machine cleaner product according to claim 1 wherein the pouch is a multi-compartment pouch, having a first compartment containing a composition in solid form and a second compartment containing a composition in liquid form wherein the solid:liquid compositions are in a weight ratio of from about 1:50 to about 50:1.

8. A machine cleaner product according to claim 1 wherein the limescale remover acid is in edge-rounded particulate form.

9. A process for making a water-soluble single- or multi-compartment pouch comprising the steps of:
a) making open pocket(s) of a water-soluble film;
b) filling and closing the pocket(s); and
c) coating the formed pouch with a moisture transfer barrier.

10. A process according to claim 9 comprising the step of edge-rounding the limescale remover acid in particulate form before filling the corresponding pocket.

11. A method of cleaning the interior of a dishwasher or laundry washing machine comprising the steps of:
a) placing a water-soluble single- or multi-compartment machine cleaner pouch according to claim 1 in the interior of the dishwasher or laundry machine; and
b) running the dishwasher or laundry machine in the absence of a dishwashing or laundry load.

12. A method according to claim 11 wherein the pouch is placed into the dispenser of a dishwasher or laundry washing machine.
